(19) United States
(12) Patent Application Publication
(10) Pub. No.: US 2020/0137623 A1
(43) Pub. Date: Apr. 30, 2020

(54) BANDWIDTH UTILIZATION DURING SILENCE FRAMES

(71) Applicant: Intel IP Corporation, Santa Clara, CA (US)

(72) Inventors: Anand NIRWANI, Bengaluru (IN); Alvandar Narasimhan GIRIDHAR, Bangalore (IN); Ganesh SHIVALINGAIAH, Bangalore (IN)

(73) Assignee: Intel IP Corporation, Santa Clara, CA (US)

(21) Appl. No.: 16/605,681

(22) PCT Filed: May 11, 2017
(86) PCT No.: PCT/US17/32141

§ 371 Date: Oct. 16, 2019

(51) Int. Cl. H04W 28/06; H04L 12/927; H04M 7/00; H04L 29/06; H04W 80/08; H04W 72/12

(52) U.S. Cl. CPC H04W 28/06; H04L 47/803; H04M 7/0006; H04L 65/1006; H04L 65/1016; H04L 65/1069; H04W 72/1289; H04L 65/608; H04L 65/80; H04L 69/24; H04M 7/0081; H04W 80/08; H04L 65/1083

(57) ABSTRACT

Briefly, in accordance with one or more embodiments, an apparatus of a user equipment (UE) comprises one or more baseband processors to generate a voice call invite message for a remote UE, and a memory to store the voice call invite message. The voice call invite message includes a header p-use-silence-period to indicate that the UE is configured to transmit or receive non-voice data during a silence period of the voice call.

### BACKGROUND

During a voice call using an Internet Protocol (IP) Multimedia Subsystem (IMS) network, for example a Voice over Long Term Evolution (VoLTE) call, dedicated allocated bandwidth can be better utilized during silence periods to exchange useful information from end user. In a VoLTE call, the network allocates dedicated bandwidth for the voice call. This bandwidth is allocated based on the highest bitrate of the audio stream negotiated for the call.

A full duplex audio call has two streams of audio comprising uplink stream and downlink stream. Generally, in a conversation, when one person is speaking, the other person will be listening and will not speak at that time. During the period when a person does not speak, in an IP or VoLTE call, a silence frame is sent. The silence frame takes only a fraction of the total available bandwidth. This leaves plenty of bandwidth unused.

### DESCRIPTION OF THE DRAWING FIGURES

Claimed subject matter is particularly pointed out and distinctly claimed in the concluding portion of the specification. Such subject matter may be understood by reference to the following detailed description when read with the accompanying drawings in which:

FIG. 1 is a flow diagram of a call establishment and real-time transport (RTP) flows in accordance with one or more embodiments;

FIG. 2 is a diagram of call invite messaging indicating the use of silence periods for bandwidth utilization in accordance with one or more embodiments;

FIG. 3 is a block diagram of an information handling system capable of implementing bandwidth utilization during silence frames in accordance with one or more embodiments;

FIG. 4 is an isometric view of an information handling system of FIG. 3 that optionally may include a touch screen in accordance with one or more embodiments;

FIG. 5 illustrates an architecture of a system of a network in accordance with some embodiments;

FIG. 6 illustrates example components of a device in accordance with some embodiments; and

FIG. 7 illustrates example interfaces of baseband circuitry in accordance with some embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. It will, however, be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. It should be noted, however, that “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

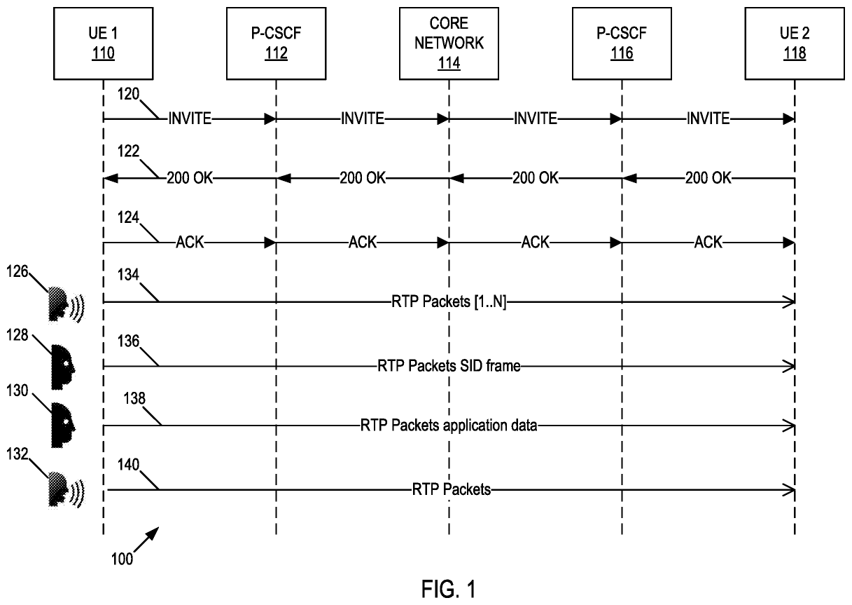

Referring now to FIG. 1, a flow diagram of a call establishment and real-time transport (RTP) flows in accordance with one or more embodiments will be discussed. As shown in flow diagram 100 of FIG. 1, an Internet Protocol Multimedia Subsystem (IMS) network type call such as a Voice over Long Term Evolution (VoLTE) call may comprise a full duplex audio call comprising two streams of audio, an uplink stream and a downlink stream. The media type and format for these streams are negotiated during call setup using Session Initiation Protocol (SIP) signaling. Generally, in a conversation, when one person is speaking the other person will be listening and will not be speaking at that time. During the period when a person does not speak in a VoLTE call, a silence frame is sent. The silence frame takes only a fraction of the total available bandwidth in either of the uplink stream or the downlink stream, thereby leaving plenty of bandwidth unused. It should be noted that although a VoLTE call is used for purposes of example, other types of packet based telephony may be utilized in general such as Internet Protocol (IP) telephony including a Voice over Internet Protocol (VoIP) call, and the scope of the claimed subject matter is not limited in this respect. Furthermore, in one or more embodiments the call flow shown in FIG. 1 may be executed in accordance a Third Generation Partnership Project (3GPP) standard such as technical standard (TS) 24.229, and the scope of the claimed subject matter is not limited in this respect.

In accordance with one or more embodiments, the unused bandwidth of a VoLTE optionally may be used to transfer data other than voiced data that will be useful to the parties in the call. The type of data that may be transferred during the VoLTE call may be defined broadly as an application in the media description (“m-line” or “m=” line) of the Session Description Protocol (SDP) which is used to describe a media stream and its associated attributes. The specific information that may be allowed to be exchanged during the call may be determined by the negotiated types as defined by a newly defined header p-use-silence-period. This header will define the types of information that the user is willing to allow to be shared during the voice call. Some non-limiting examples of data that can be exchanged and their definitions include:
message: a short message from user
location: a location of the device
localtime: a time of the day
   It should be noted, however, that these are merely some examples of the types of data that may be exchanged between users during a VoLTE call, and the scope of the claimed subject matter is not limited in this respect.

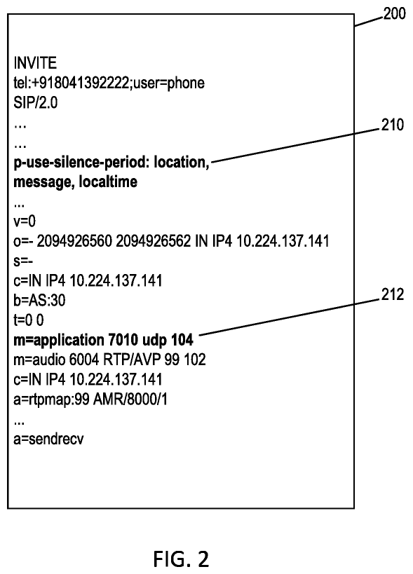

As shown in FIG. 1, a first user equipment (UE 1) 110 sends a call invitation (INVITE) 120 to a second UE (UE 2) 118 which is transferred from UE 110 to UE 118 via a first Proxy Call Session Control Function (P-CSCF) 112, core network 114, and a second P-CSCF 116. Such an operation may start with a request from UE 110 to core network 114 with the following code. In reply, if the request has succeeded, UE 118 may send a 200 OK status code message 122 back to UE 110, and then UE 110 may send an acknowledgment message 124 back to UE 118. At that point, the VoLTE call may proceed with the first user, the user of UE 110, speaking to the second user, the user of UE 110. While the first user is speaking at operation 126, real-time transport protocol (RTP) packets 124 may be sent from UE 110 to UE 118. Next, at operation 128 the first user is listening to the second user, but the first user is not speaking. If the header p-use-silence period is configured in the call invite, as discussed in more detail with respect to FIG. 2 below, then an RTP packets Silence Indicator Description (SID) frame may be sent from UE 110 to UE 118 during operation 128. Then while the first user is still silent during operation 130, RTP packets application data 138 may be sent from UE 110 to UE 118, taking advantage of the unused bandwidth during operation 130 during which the first user is not speaking. Then, if the first user begins speaking again at operation 132, RTP packets 140 may be transferred from UE 110 to UE 118. The reverse type of operations similarly will apply when the second user is not speaking wherein RTP packets SID frame 136 may be sent from UE 118 to UE 110 and then RTP packets application data may be sent from UE 118 to UE 110 while the second user remains silent. An example of a call invite message using the header p-use-silence period to indicate the use of silence periods for bandwidth utilization is shown in and described with respect to FIG. 2, below

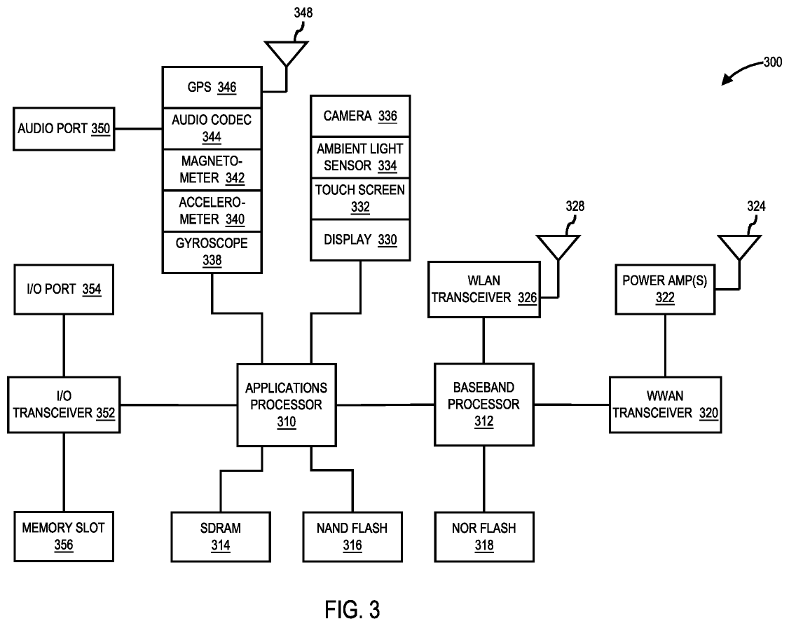

Referring now to FIG. 2, a diagram of call invite messaging indicating the use of silence periods for bandwidth utilization in accordance with one or more embodiments will be discussed. As shown in FIG. 3, the call invite message 200 may include a header p-use-silence period 210 to indicate the use of silence periods for bandwidth utilization during a VoLTE call. Fields in the header 210 may indicate the type of data requested to be sent during silence periods, for example location data, message data, and/or local time (localtime) data, among other types of data. The type of data is defined broadly as application in the m-line of SDP 212 of the call invite message 200. In one or more embodiments, example SIP signaling exchanged between UE 110 and UE 118 may be as follows.

Request from UE 110 to Core Network 114:
INVITE tel:+918041392222;user=phone SIP/2.0
Via: SIP/2.0/TCP [fc01:abab:cdcd:efe1::1]: 5060;branch=z9hG4bKb97789d
Route: <sip:[fc01:cafe::1]: 5060;lr>

### Max-Forwards: 70

To: <tel:+918041392222;user=phone>
From: <tel:12345678>;tag=72a92e39
Call-ID: 8681b1d40c9000803838663300@fc01:abab:cdcd:efe1::1

### CSeq: 926060360 INVITE

Accept: application/sdp,application/3gpp-ims+xml,application/vnd.3gpp.mid-call+xml,application/vnd.3gpp.state-and-event-info+xml

### Accept-Language: en

### Allow:

### INVITE,ACK,CANCEL,BYE,PRACK,OPTIONS,REFER,NOTIFY,SUBSCRIBE,UPDATE

Contact: <sip:[fc01:abab:cdcd:efe1::1]: 5060>;+sip.instance=“<urn:gsma:imei:00499901-064000-0>”;+g.3gpp.icsi-ref=“urn%3Aurn-7%3A3gpp-service.ims.icsi.mmtel”;+g.3gpp.smsip;audio;+g.3gpp.mid-call;+g.3gpp.ps2cs-srvcc-orig-pre-alerting;+g.3gpp.srvcc-alerting
Content-Type: application/sdp
Supported: replaces,100rel,timer,norefersub
Session-Expires: 1800;refresher=uac

### Min-SE: 90

Privacy: none
P-Use-Silence-Period: location, message, localtime

### P-Preferred-Identity: tel:12345678

P-Access-Network-Info: 3GPP-E-UIRAN-FDD;utran-cell-id-3gpp=0010100010000100
Accept-Contact: *;+g.3gpp.icsi-ref=“urn%3Aurn-7%3A3gpp-service.ims.icsi.mmtel”;require
P-Preferred-Service: urn:urn-7:3gpp-service.ims.icsi.mmtel

### Content-Length: 437

v=0
o=−179905 179906 IN IP6 fc01:abab:cdcd:efe1::1
s=−
c=IN IP6 fc01:abab:cdcd:efe1::1
t=0 0
P-Use-Silence-Period: location, message, localtime

### P-Preferred-Identity: tel:12345678

P-Access-Network-Info: 3GPP-E-UZTRAN-FDD;utran-cell-id-3gpp=0010100010000100
Accept-Contact: *;+g.3gpp.icsi-ref=“urn%3Aurn-7%3A3gpp-service.ims.icsi.mmtel”;require
P-Preferred-Service: urn:urn-7:3gpp-service.ims.icsi.mmtel

### Content-Length: 437

v=0
o=−179905 179906 IN IP6 fc01:abab:cdcd:efe1::1
s=−
c=IN IP6 fc01:abab:cdcd:efe1::1
t=0 0
m=application 7010 udp 104
m=audio 6000 RTP/AVP 97 99 102
c=IN IP6 fc01:abab:cdcd:efe1::1
a=rtpmap:97 AMR-WB/16000/1
a=fmtp:97 mode-change-capability=2; max-red=220
a=rtpmap:99 AMR/8000/1
a=fmtp:99 mode-change-capability=2; max-red=220
a=rtpmap:102 telephone-event/16000
a=fmtp:102 0-15
a=ptime:20
a=maxptime:240
a=sendrecv
Provisional Response from Core Network 114 to UE 110:

### SIP/2.0 100 Trying

Via: SIP/2.0/TCP [fc01:abab:cdcd:efe1::1]: 5060;received=fc01:abab:cdcd:efe1::1;branch=z9hG4bKb97789d
Call-ID: 8681b1d40c9000803838663300@fc01:abab:cdcd:efe1::1
From: <tel:12345678>;tag=72a92e39
To: <tel:+918041392222;user=phone>

### CSeq: 926060360 INVITE

### Content-Length: 0

Provisional Response from Core Network 114 to UE:

### SIP/2.0 180 Ringing

Via: SIP/2.0/TCP [fc01:abab:cdcd:efe1::1]: 5060;received=fc01:abab:cdcd:efe1::1;branch=z9hG4bKb97789d
Call-ID: 8681b1d40c9000803838663300@fc01:abab:cdcd:efe1::1
From: <tel:12345678>;tag=72a92e39
To: <tel:+918041392222;user=phone>;tag=EJ1VIcCoDNpplZYOv

### CSeq: 926060360 INVITE

Contact: <sip:[fc01:cafe::1]: 5060>;+g.3gpp.icsi-ref=“urn%3Aurn-7%3A3gpp-service.ims.icsi.mmtel”;+g.3gpp.srvcc;+g.3gpp.srvcc-alerting;+g.3gpp.ps2cs-srvcc-orig-pre-alerting;+g.3gpp.cs2ps-srvcc-alerting;+g.3gpp.cs2ps-srvcc

### Allow: INVITE, ACK, BYE, CANCEL, UPDATE, PRACK

Feature-Caps: *;+g.3gpp.srvcc;+g.3gpp.srvcc-alerting;+g.3gpp.ps2cs-srvcc-orig-pre-alerting;video;+g.3gpp.mid-call

### Require: 100rel

### RSeq: 15267

### Content-Length: 0

Final Response from Core Network 114 to HE 110:

### SIP/2.0 200 OK

Via: SIP/2.0/TCP [fc01:abab:cdcd:efe1::1]: 5060;received=fc01:abab:cdcd:efe1::1;branch=z9hG4bKb97789d
Call-ID: 8681b1d40c9000803838663300@fc01:abab:cdcd:efe1::1
From: <tel:12345678>;tag=72a92e39
To: <tel:+918041392222;user=phone>;tag=EJ1VIcCoDNpplZYOv

### CSeq: 926060360 INVITE

### Allow: INVITE, ACK, BYE, CANCEL, UPDATE, PRACK

Feature-Caps: *;+g.3gpp.srvcc;+g.3gpp.srvcc-alerting;+g.3gpp.ps2cs-srvcc-orig-pre-alerting;video;+g.3gpp.mid-call
Contact: <sip:[fc01:cafe::1]: 5060>;+g.3gpp.icsi-ref=“urn%3Aurn-7%3A3gpp-service.ims.icsi.mmtel”;+g.3gpp.srvcc;+g.3gpp.srvcc-alerting;+g.3gpp.ps2cs-srvcc-orig-pre-alerting;+g.3gpp.cs2ps-srvcc-alerting;+g.3gpp.cs2ps-srvcc
Supported: 100rel, precondition, sec-agree, recipient-list-subscribe, 100rel
P-Use-Silence-Period: location, message, localtime
Feature-Caps: *;+g.3gpp.srvcc
Content-Type: application/sdp

### Content-Length: 346

v=0
o=−179905 179907 IN IP6 fc01:cafe::1
s=−
c=IN IP6 fc01:cafe::1
t=0 0
m=application 35160 udp 104
m=audio 49200 RTP/AVP 98 102
c=IN IP6 fc01:cafe::1
a=rtpmap:98 AMR-WB/16000/1
a=fmtp:98 mode-change-capability=2; octet-align=1; max-red=220
a=rtpmap:102 telephone-event/16000
a=fmtp:102 0-15
a=ptime:20
a=maxptime:240
a=sendrecv
Ack from UE 110 to Core Network 114 for Call Establishment:
ACK sip:[fc01:cafe::1]: 5060 SIP/2.0
Via: SIP/2.0/UDP [fc01:abab:cdcd:efe1::1]: 5060;branch=z9hG4bKbf38759921519067

### Max-Forwards: 70

To: <tel:+918041392222;user=phone>;tag=EJ1VIcCoDNpplZYOv
From: <tel:12345678>;tag=72a92e39
Call-ID: 8681b1d40c9000803838663300@fc01:abab:cdcd:efe1::1

### CSeq: 926060360 ACK

Contact: <sip:[fc01:abab:cdcd:efe1::1]: 5060>;+sip.instance=“<urn:gsma:imei:00499901-064000-0>”;+g.3gpp.icsi-ref=“urn%3Aurn-7%3A3gpp-service.ims.icsi.mmtel”;+g.3gpp.smsip;audio;+g.3gpp.mid-call;+g.3gpp.ps2cs-srvcc-orig-pre-alerting;+g.3gpp.srvcc-alerting

### Content-Length: 0

In one or more embodiments, once a silence packet is sent, for the next 160 milliseconds, no other audio packet is required to be sent if the silence is maintained. The seven audio packets that would normally be sent due to active voice will be avoided in a silence period. During this period, the bandwidth may be used to send other data to the peer as described above. The RTP packet with application specific frame as show as below may be sent.

RTP Packet Format with Application Data:

Referring now to FIG. 3, a block diagram of an information handling system capable of implementing security for paging messages in accordance with one or more embodiments will be discussed. Although information handling system 300 represents one example of several types of computing platforms, information handling system 300 may include more or fewer elements and/or different arrangements of elements than shown in FIG. 3, and the scope of the claimed subject matter is not limited in these respects. In one embodiment, information handling system 300 may tangibly embody an apparatus of a user equipment (UE), comprising one or more baseband processors to generate a voice call invite message for a remote UE, and a memory to store the voice call invite message, wherein the voice call invite message includes a header p-use-silence-period to indicate that the UE is configured to transmit or receive non-voice data during a silence period of the voice call. In another embodiment, information handling system 300 may tangibly embody an apparatus of a user equipment (UE) comprising one or more baseband processors to decode a voice call invite message from a remote UE, and a memory to store the call invite message, wherein the call invite message includes a header p-use-silence-period to indicate that the UE is configured to transmit or receive non-voice data during a silence period of the voice call.

In one or more embodiments, information handling system 300 may include one or more applications processors 310 and one or more baseband processors 312. Applications processor 310 may be utilized as a general-purpose processor to run applications and the various subsystems for information handling system 300. Applications processor 310 may include a single core or alternatively may include multiple processing cores. One or more of the cores may comprise a digital signal processor or digital signal processing (DSP) core. Furthermore, applications processor 310 may include a graphics processor or coprocessor disposed on the same chip, or alternatively a graphics processor coupled to applications processor 310 may comprise a separate, discrete graphics chip. Applications processor 310 may include on board memory such as cache memory, and further may be coupled to external memory devices such as synchronous dynamic random access memory (SDRAM) 314 for storing and/or executing applications during operation, and NAND flash 316 for storing applications and/or data even when information handling system 300 is powered off In one or more embodiments, instructions to operate or configure the information handling system 300 and/or any of its components or subsystems to operate in a manner as described herein may be stored on an article of manufacture comprising a non-transitory storage medium. In one or more embodiments, the storage medium may comprise any of the memory devices shown in and described herein, although the scope of the claimed subject matter is not limited in this respect. Baseband processor 312 may control the broadband radio functions for information handling system 300. Baseband processor 312 may store code for controlling such broadband radio functions in a NOR flash 318. Baseband processor 312 controls a wireless wide area network (WWAN) transceiver 320 which is used for modulating and/or demodulating broadband network signals, for example for communicating via a 3GPP LTE or LTE-Advanced network or the like.

In general, WWAN transceiver 320 may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 12), 3GPP Rel. 14 (3rd Generation Partnership Project Release 12), 3GPP LTE Extra, NR (5G), LTE Licensed-Assisted Access (LAA), UMTS Terrestrial Radio Access (U IRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, millimeter wave (mmWave) standards in general for wireless systems operating at 10-90 GHz and above such as WiGig, IEEE 802.11ad, IEEE 802.11ay, and so on, and/or general telemetry transceivers, and in general any type of RF circuit or RFI sensitive circuit. It should be noted that such standards may evolve over time, and/or new standards may be promulgated, and the scope of the claimed subject matter is not limited in this respect.

The WWAN transceiver 320 couples to one or more power amps 322 respectively coupled to one or more antennas 324 for sending and receiving radio-frequency signals via the WWAN broadband network. The baseband processor 312 also may control a wireless local area network (WLAN) transceiver 326 coupled to one or more suitable antennas 328 and which may be capable of communicating via a Wi-Fi, Bluetooth®, and/or an amplitude modulation (AM) or frequency modulation (FM) radio standard including an IEEE 802.11 a/b/g/n standard or the like. It should be noted that these are merely example implementations for applications processor 310 and baseband processor 312, and the scope of the claimed subject matter is not limited in these respects. For example, any one or more of SDRAM 314, NAND flash 316 and/or NOR flash 318 may comprise other types of memory technology such as magnetic memory, chalcogenide memory, phase change memory, or ovonic memory, and the scope of the claimed subject matter is not limited in this respect.

In one or more embodiments, applications processor 310 may drive a display 330 for displaying various information or data, and may further receive touch input from a user via a touch screen 332 for example via a finger or a stylus. An ambient light sensor 334 may be utilized to detect an amount of ambient light in which information handling system 300 is operating, for example to control a brightness or contrast value for display 330 as a function of the intensity of ambient light detected by ambient light sensor 334. One or more cameras 336 may be utilized to capture images that are processed by applications processor 310 and/or at least temporarily stored in NAND flash 316. Furthermore, applications processor may couple to a gyroscope 338, accelerometer 340, magnetometer 342, audio coder/decoder (CODEC) 344, and/or global positioning system (GPS) controller 346 coupled to an appropriate GPS antenna 348, for detection of various environmental properties including location, movement, and/or orientation of information handling system 300. Alternatively, controller 346 may comprise a Global Navigation Satellite System (GNSS) controller. Audio CODEC 344 may be coupled to one or more audio ports 350 to provide microphone input and speaker outputs either via internal devices and/or via external devices coupled to information handling system via the audio ports 350, for example via a headphone and microphone jack. In addition, applications processor 310 may couple to one or more input/output (I/O) transceivers 352 to couple to one or more I/O ports 354 such as a universal serial bus (USB) port, a high-definition multimedia interface (HDMI) port, a serial port, and so on. Furthermore, one or more of the I/O transceivers 352 may couple to one or more memory slots 356 for optional removable memory such as secure digital (SD) card or a subscriber identity module (SIM) card, although the scope of the claimed subject matter is not limited in these respects.

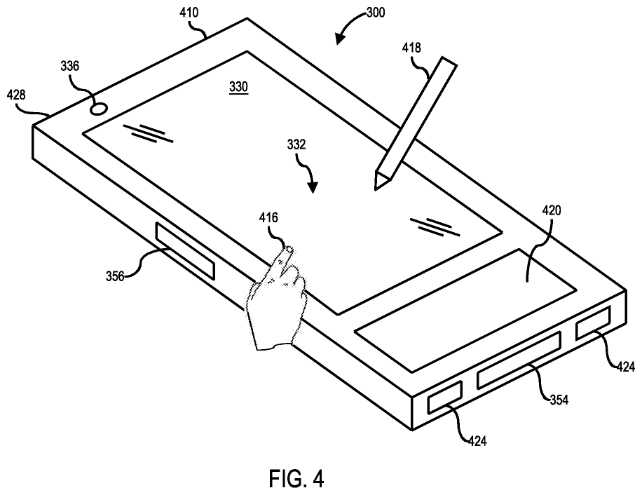

Referring now to FIG. 4, an isometric view of an information handling system of FIG. 3 that optionally may include a touch screen in accordance with one or more embodiments will be discussed. FIG. 4 shows an example implementation of information handling system 300 of FIG. 3 tangibly embodied as a cellular telephone, smartphone, or tablet type device or the like. The information handling system 300 may comprise a housing 410 having a display 330 which may include a touch screen 332 for receiving tactile input control and commands via a finger 416 of a user and/or a via stylus 418 to control one or more applications processors 410. The housing 410 may house one or more components of information handling system 300, for example one or more applications processors 310, one or more of SDRAM 314, NAND flash 316, NOR flash 318, baseband processor 312, and/or WWAN transceiver 320. The information handling system 300 further optionally may include a physical actuator area 420 which may comprise a keyboard or buttons for controlling information handling system via one or more buttons or switches. The information handling system 300 may also include a memory port or slot 356 for receiving non-volatile memory such as flash memory, for example in the form of a secure digital (SD) card or a subscriber identity module (SIM) card. Optionally, the information handling system 300 may further include one or more speakers and/or microphones 424 and a connection port 354 for connecting the information handling system 300 to another electronic device, dock, display, battery charger, and so on. In addition, information handling system 300 may include a headphone or speaker jack 428 and one or more cameras 336 on one or more sides of the housing 710. It should be noted that the information handling system 300 of FIG. 4 may include more or fewer elements than shown, in various arrangements, and the scope of the claimed subject matter is not limited in this respect.

As used herein, the terms “circuit” or “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

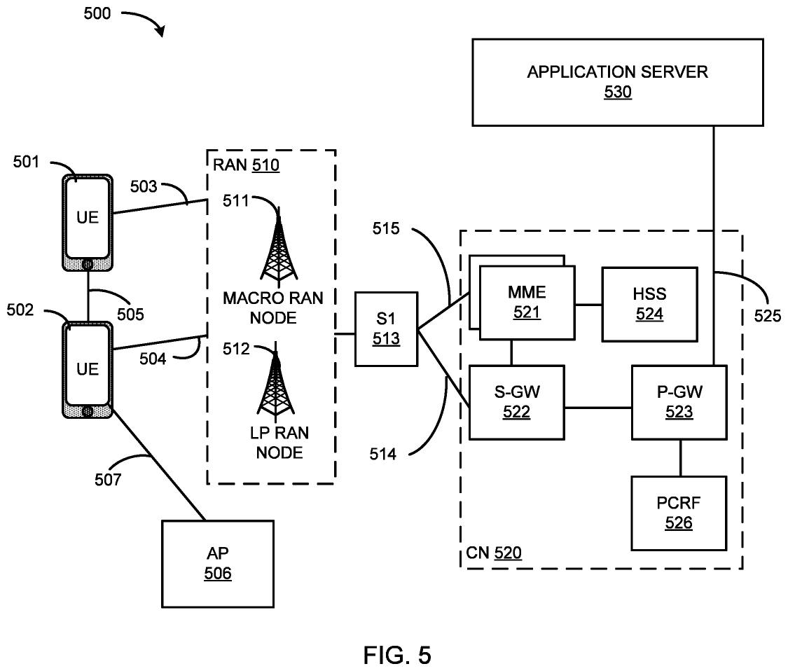

FIG. 5 illustrates an architecture of a system 500 of a network in accordance with some embodiments. The system 500 is shown to include a user equipment (UE) 501 and a UE 502. The UEs 501 and 502 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 501 and 502 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 501 and 502 may be configured to connect, e.g., communicatively couple, with a radio access network (RAN) 510—the RAN 510 may be, for example, an Evolved Universal Mobile Telecommunications System (UMTS) Terrestrial Radio Access Network (E-UTRAN), a NextGen RAN (NG RAN), or some other type of RAN. The UEs 501 and 502 utilize connections 503 and 504, respectively, each of which comprises a physical communications interface or layer (discussed in further detail below); in this example, the connections 503 and 504 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 501 and 502 may further directly exchange communication data via a ProSe interface 505. The ProSe interface 505 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 502 is shown to be configured to access an access point (AP) 506 via connection 507. The connection 507 can comprise a local wireless connection, such as a connection consistent with any IEEE 802.11 protocol, wherein the AP 506 would comprise a wireless fidelity (WiFi®) router. In this example, the AP 506 is shown to be connected to the Internet without connecting to the core network of the wireless system (described in further detail below).

The RAN 510 can include one or more access nodes that enable the connections 503 and 504. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN 510 may include one or more RAN nodes for providing macrocells, e.g., macro RAN node 511, and one or more RAN nodes for providing femtocells or picocells (e.g., cells having smaller coverage areas, smaller user capacity, or higher bandwidth compared to macrocells), e.g., low power (LP) RAN node 512.

Any of the RAN nodes 511 and 512 can terminate the air interface protocol and can be the first point of contact for the UEs 501 and 502. In some embodiments, any of the RAN nodes 511 and 512 can fulfill various logical functions for the RAN 510 including, but not limited to, radio network controller (RNC) functions such as radio bearer management, uplink and downlink dynamic radio resource management and data packet scheduling, and mobility management.

In accordance with some embodiments, the UEs 501 and 502 can be configured to communicate using Orthogonal Frequency-Division Multiplexing (OFDM) communication signals with each other or with any of the RAN nodes 511 and 512 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 511 and 512 to the UEs 501 and 502, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UEs 501 and 502. The physical downlink control channel (PDCCH) may carry information about the transport format and resource allocations related to the PDSCH channel, among other things. It may also inform the UEs 501 and 502 about the transport format, resource allocation, and H-ARQ (Hybrid Automatic Repeat Request) information related to the uplink shared channel. Typically, downlink scheduling (assigning control and shared channel resource blocks to the UE 102 within a cell) may be performed at any of the RAN nodes 511 and 512 based on channel quality information fed back from any of the UEs 501 and 502. The downlink resource assignment information may be sent on the PDCCH used for (e.g., assigned to) each of the UEs 501 and 502.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN 510 is shown to be communicatively coupled to a core network (CN) 520—via an S1 interface 513. In embodiments, the CN 520 may be an evolved packet core (EPC) network, a NextGen Packet Core (NPC) network, or some other type of CN. In this embodiment the S1 interface 513 is split into two parts: the S1-U interface 514, which carries traffic data between the RAN nodes 511 and 512 and the serving gateway (S-GW) 522, and the S1-mobility management entity (MME) interface 515, which is a signaling interface between the RAN nodes 511 and 512 and MMEs 521.

In this embodiment, the CN 520 comprises the MMEs 521, the S-GW 522, the Packet Data Network (PDN) Gateway (P-GW) 523, and a home subscriber server (HSS) 524. The MMEs 521 may be similar in function to the control plane of legacy Serving General Packet Radio Service (GPRS) Support Nodes (SGSN). The MMEs 521 may manage mobility aspects in access such as gateway selection and tracking area list management. The HSS 524 may comprise a database for network users, including subscription-related information to support the network entities' handling of communication sessions. The CN 520 may comprise one or several HSSs 524, depending on the number of mobile subscribers, on the capacity of the equipment, on the organization of the network, etc. For example, the HSS 524 can provide support for routing/roaming, authentication, authorization, naming/addressing resolution, location dependencies, etc.

The S-GW 522 may terminate the S1 interface 513 towards the RAN 510, and routes data packets between the RAN 510 and the CN 520. In addition, the S-GW 522 may be a local mobility anchor point for inter-RAN node handovers and also may provide an anchor for inter-3GPP mobility. Other responsibilities may include lawful intercept, charging, and some policy enforcement.

The P-GW 523 may terminate an SGi interface toward a PDN. The P-GW 523 may route data packets between the EPC network 523 and external networks such as a network including the application server 530 (alternatively referred to as application function (AF)) via an Internet Protocol (IP) interface 525. Generally, the application server 530 may be an element offering applications that use IP bearer resources with the core network (e.g., UMTS Packet Services (PS) domain, LTE PS data services, etc.). In this embodiment, the P-GW 523 is shown to be communicatively coupled to an application server 530 via an IP communications interface 525. The application server 530 can also be configured to support one or more communication services (e.g., Voice-over-Internet Protocol (VoIP) sessions, PTT sessions, group communication sessions, social networking services, etc.) for the UEs 501 and 502 via the CN 520.

The P-GW 523 may further be a node for policy enforcement and charging data collection. Policy and Charging Enforcement Function (PCRF) 526 is the policy and charging control element of the CN 520. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 526 may be communicatively coupled to the application server 530 via the P-GW 523. The application server 530 may signal the PCRF 526 to indicate a new service flow and select the appropriate Quality of Service (QoS) and charging parameters. The PCRF 526 may provision this rule into a Policy and Charging Enforcement Function (PCEF) (not shown) with the appropriate traffic flow template (TFT) and QoS class of identifier (QCI), which commences the QoS and charging as specified by the application server 530.

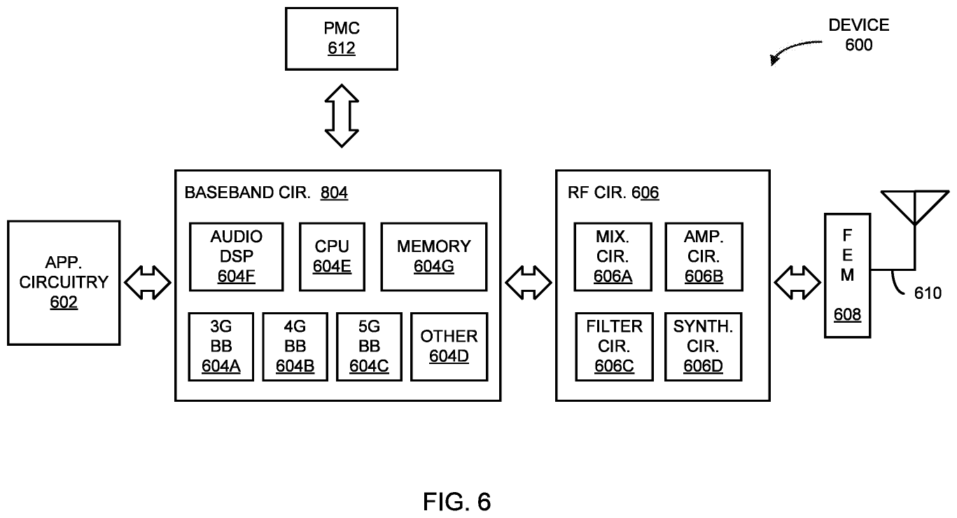

FIG. 6 illustrates example components of a device 600 in accordance with some embodiments. In some embodiments, the device 600 may include application circuitry 602, baseband circuitry 604, Radio Frequency (RF) circuitry 606, front-end module (FEM) circuitry 608, one or more antennas 610, and power management circuitry (PMC) 612 coupled together at least as shown. The components of the illustrated device 600 may be included in a UE or a RAN node. In some embodiments, the device 600 may include less elements (e.g., a RAN node may not utilize application circuitry 602, and instead include a processor/controller to process IP data received from an EPC). In some embodiments, the device 600 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 602 may include one or more application processors. For example, the application circuitry 602 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 600. In some embodiments, processors of application circuitry 602 may process IP data packets received from an EPC.

The baseband circuitry 604 may include circuitry such as, but not limited to, one or more single-core or multi-core processors. The baseband circuitry 604 may include one or more baseband processors or control logic to process baseband signals received from a receive signal path of the RF circuitry 606 and to generate baseband signals for a transmit signal path of the RF circuitry 606. Baseband processing circuitry 604 may interface with the application circuitry 602 for generation and processing of the baseband signals and for controlling operations of the RF circuitry 606. For example, in some embodiments, the baseband circuitry 604 may include a third generation (3G) baseband processor 604A, a fourth generation (4G) baseband processor 604B, a fifth generation (5G) baseband processor 604C, or other baseband processor(s) 604D for other existing generations, generations in development or to be developed in the future (e.g., second generation (2G), si6h generation (6G), etc.). The baseband circuitry 604 (e.g., one or more of baseband processors 604A-D) may handle various radio control functions that enable communication with one or more radio networks via the RF circuitry 606. In other embodiments, some or all of the functionality of baseband processors 604A-D may be included in modules stored in the memory 604G and executed via a Central Processing Unit (CPU) 604E. The radio control functions may include, but are not limited to, signal modulation/demodulation, encoding/decoding, radio frequency shifting, etc. In some embodiments, modulation/demodulation circuitry of the baseband circuitry 604 may include Fast-Fourier Transform (FFT), preceding, or constellation mapping/demapping functionality. In some embodiments, encoding/decoding circuitry of the baseband circuitry 604 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 604 may include one or more audio digital signal processor(s) (DSP) 604F. The audio DSP(s) 604F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 604 and the application circuitry 602 may be implemented together such as, for example, on a system on a chip (SOC).

In some embodiments, the baseband circuitry 604 may provide for communication compatible with one or more radio technologies. For example, in some embodiments, the baseband circuitry 604 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 604 is configured to support radio communications of more than one wireless protocol may be referred to as multi-mode baseband circuitry.

RF circuitry 606 may enable communication with wireless networks using modulated electromagnetic radiation through a non-solid medium. In various embodiments, the RF circuitry 606 may include switches, filters, amplifiers, etc. to facilitate the communication with the wireless network. RF circuitry 606 may include a receive signal path which may include circuitry to down-convert RF signals received from the FEM circuitry 608 and provide baseband signals to the baseband circuitry 604. RF circuitry 606 may also include a transmit signal path which may include circuitry to up-convert baseband signals provided by the baseband circuitry 604 and provide RF output signals to the FEM circuitry 608 for transmission.

In some embodiments, the receive signal path of the RF circuitry 606 may include mixer circuitry 606a, amplifier circuitry 606b and filter circuitry 606c. In some embodiments, the transmit signal path of the RF circuitry 606 may include filter circuitry 606c and mixer circuitry 606a. RF circuitry 606 may also include synthesizer circuitry 606d for synthesizing a frequency for use by the mixer circuitry 606a of the receive signal path and the transmit signal path. In some embodiments, the mixer circuitry 606a of the receive signal path may be configured to down-convert RF signals received from the FEM circuitry 608 based on the synthesized frequency provided by synthesizer circuitry 606d. The amplifier circuitry 606b may be configured to amplify the down-converted signals and the filter circuitry 606c may be a low-pass filter (LPF) or band-pass filter (BPF) configured to remove unwanted signals from the down-converted signals to generate output baseband signals. Output baseband signals may be provided to the baseband circuitry 604 for further processing. In some embodiments, the output baseband signals may be zero-frequency baseband signals, although this is not a requirement. In some embodiments, mixer circuitry 606a of the receive signal path may comprise passive mixers, although the scope of the embodiments is not limited in this respect.

In some embodiments, the mixer circuitry 606a of the transmit signal path may be configured to up-convert input baseband signals based on the synthesized frequency provided by the synthesizer circuitry 606d to generate RF output signals for the FEM circuitry 608. The baseband signals may be provided by the baseband circuitry 604 and may be filtered by filter circuitry 606c.

In some embodiments, the mixer circuitry 606a of the receive signal path and the mixer circuitry 606a of the transmit signal path may include two or more mixers and may be arranged for quadrature downconversion and upconversion, respectively. In some embodiments, the mixer circuitry 606a of the receive signal path and the mixer circuitry 606a of the transmit signal path may include two or more mixers and may be arranged for image rejection (e.g., Hartley image rejection). In some embodiments, the mixer circuitry 606a of the receive signal path and the mixer circuitry 606a may be arranged for direct downconversion and direct upconversion, respectively. In some embodiments, the mixer circuitry 606a of the receive signal path and the mixer circuitry 606a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 606 may include analog-to-digital converter (ADC) and digital-to-analog converter (DAC) circuitry and the baseband circuitry 604 may include a digital baseband interface to communicate with the RF circuitry 606.

In some dual-mode embodiments, a separate radio IC circuitry may be provided for processing signals for each spectrum, although the scope of the embodiments is not limited in this respect. In some embodiments, the synthesizer circuitry 606d may be a fractional-N synthesizer or a fractional N/N+1 synthesizer, although the scope of the embodiments is not limited in this respect as other types of frequency synthesizers may be suitable. For example, synthesizer circuitry 606d may be a delta-sigma synthesizer, a frequency multiplier, or a synthesizer comprising a phase-locked loop with a frequency divider.

The synthesizer circuitry 606d may be configured to synthesize an output frequency for use by the mixer circuitry 606a of the RF circuitry 606 based on a frequency input and a divider control input. In some embodiments, the synthesizer circuitry 606d may be a fractional N/N+1 synthesizer.

In some embodiments, frequency input may be provided by a voltage controlled oscillator (VCO), although that is not a requirement. Divider control input may be provided by either the baseband circuitry 604 or the applications processor 602 depending on the desired output frequency. In some embodiments, a divider control input (e.g., N) may be determined from a look-up table based on a channel indicated by the applications processor 602.

Synthesizer circuitry 606d of the RF circuitry 606 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 606d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 606 may include an IQ/polar converter.

FEM circuitry 608 may include a receive signal path which may include circuitry configured to operate on RF signals received from one or more antennas 610, amplify the received signals and provide the amplified versions of the received signals to the RF circuitry 606 for further processing. FEM circuitry 608 may also include a transmit signal path which may include circuitry configured to amplify signals for transmission provided by the RF circuitry 606 for transmission by one or more of the one or more antennas 610. In various embodiments, the amplification through the transmit or receive signal paths may be done solely in the RF circuitry 606, solely in the FEM 608, or in both the RF circuitry 606 and the FEM 608.

In some embodiments, the FEM circuitry 608 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 606). The transmit signal path of the FEM circuitry 608 may include a power amplifier (PA) to amplify input RF signals (e.g., provided by RF circuitry 606), and one or more filters to generate RF signals for subsequent transmission (e.g., by one or more of the one or more antennas 610).

In some embodiments, the PMC 612 may manage power provided to the baseband circuitry 604. In particular, the PMC 612 may control power-source selection, voltage scaling, battery charging, or DC-to-DC conversion. The PMC 612 may often be included when the device 600 is capable of being powered by a battery, for example, when the device is included in a UE. The PMC 612 may increase the power conversion efficiency while providing desirable implementation size and heat dissipation characteristics.

While FIG. 6 shows the PMC 612 coupled only with the baseband circuitry 604. However, in other embodiments, the PMC 612 may be additionally or alternatively coupled with, and perform similar power management operations for, other components such as, but not limited to, application circuitry 602, RF circuitry 606, or FEM 608.

In some embodiments, the PMC 612 may control, or otherwise be part of, various power saving mechanisms of the device 600. For example, if the device 600 is in an RRC_Connected state, where it is still connected to the RAN node as it expects to receive traffic shortly, then it may enter a state known as Discontinuous Reception Mode (DRX) after a period of inactivity. During this state, the device 600 may power down for brief intervals of time and thus save power.

If there is no data traffic activity for an extended period of time, then the device 600 may transition off to an RRC_Idle state, where it disconnects from the network and does not perform operations such as channel quality feedback, handover, etc. The device 600 goes into a very low power state and it performs paging where again it periodically wakes up to listen to the network and then powers down again. The device 600 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 602 and processors of the baseband circuitry 604 may be used to execute elements of one or more instances of a protocol stack. For example, processors of the baseband circuitry 604, alone or in combination, may be used execute Layer 3, Layer 2, or Layer 1 functionality, while processors of the application circuitry 604 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

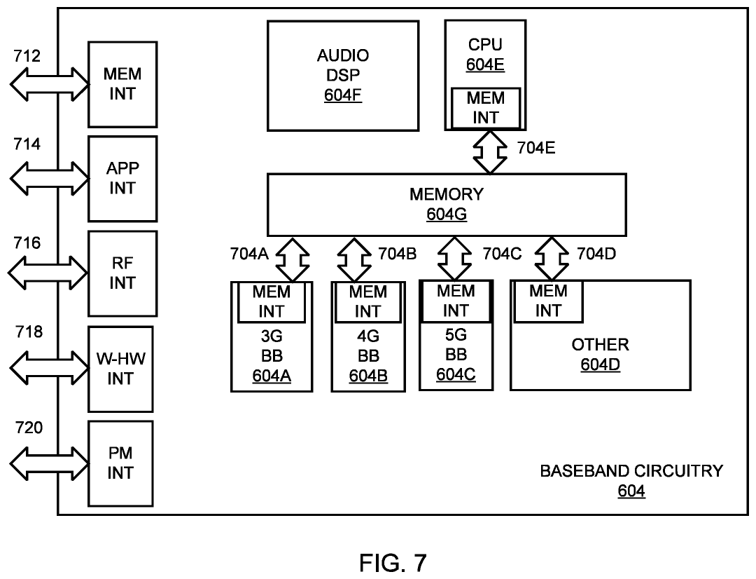

FIG. 7 illustrates example interfaces of baseband circuitry in accordance with some embodiments. As discussed above, the baseband circuitry 604 of FIG. 6 may comprise processors 604A-604E and a memory 604G utilized by said processors. Each of the processors 604A-604E may include a memory interface, 704A-704E, respectively, to send/receive data to/from the memory 604G.

The baseband circuitry 604 may further include one or more interfaces to communicatively couple to other circuitries/devices, such as a memory interface 712 (e.g., an interface to send/receive data to/from memory external to the baseband circuitry 604), an application circuitry interface 714 (e.g., an interface to send/receive data to/from the application circuitry 602 of FIG. 6), an RF circuitry interface 716 (e.g., an interface to send/receive data to/from RF circuitry 606 of FIG. 6), a wireless hardware connectivity interface 718 (e.g., an interface to send/receive data to/from Near Field Communication (NFC) components, Bluetooth® components (e.g., Bluetooth® Low Energy), Wi-Fi® components, and other communication components), and a power management interface 720 (e.g., an interface to send/receive power or control signals to/from the PMC 612.

The following are example implementations of the subject matter described herein. It should be noted that any of the examples and the variations thereof described herein may be used in any permutation or combination of any other one or more examples or variations, although the scope of the claimed subject matter is not limited in these respects. Example one is directed to an apparatus of a user equipment (UE) comprising one or more baseband processors to generate a voice call invite message for a remote UE, and a memory to store the voice call invite message. wherein the voice call invite message includes a header p-use-silence-period to indicate that the UE is configured to transmit or receive non-voice data during a silence period of the voice call. Example two may include the subject matter of example one or any of the examples described herein, further comprising a radio-frequency (RF) transceiver to transmit the voice call invite message to the remote UE via a core network. Example three may include the subject matter of example one or any of the examples described herein, wherein the header indicates a type of non-voice data to be transmitted or received during a silence period. Example four may include the subject matter of example one or any of the examples described herein, wherein the one or more baseband processor are to generate one or more non-voice data packets to be sent to the remote UE during a silence period of the UE. Example five may include the subject matter of example one or any of the examples described herein, wherein the one or more baseband processors are to decode one or more non-voice data packets received from the remote UE during a silence period of the remote UE. Example six may include the subject matter of example one or any of the examples described herein, wherein the one or more baseband processors are to generate a Silence Indicator Description (SID) frame to be sent from the UE to the remote UE prior to sending one or more non-voice data packets to the remote UE during a silence period of the UE. Example seven may include the subject matter of example one or any of the examples described herein, wherein the voice call comprises a Voice over Long Term Evolution (VoLTE) call, an Internet Protocol (IP) telephony call, an Internet Protocol Multimedia Subsystem (IMS) call, or a Voice over Internet Protocol (VoIP) call, or a combination thereof. Example eight may include the subject matter of example one or any of the examples described herein, wherein the non-voice data comprises message data, location data, or time data, or a combination thereof.

Example nine is directed to an apparatus of a user equipment (UE) comprising one or more baseband processors to decode a voice call invite message from a remote UE, and a memory to store the call invite message, wherein the call invite message includes a header p-use-silence-period to indicate that the UE is configured to transmit or receive non-voice data during a silence period of the voice call. Example ten may include the subject matter of example nine or any of the examples described herein, further comprising a radio-frequency (RF) transceiver to receive the voice call invite message from the remote UE via a core network, and to transmit a 200 OK message to the remote UE via the core network in reply to the voice call invite message. Example eleven may include the subject matter of example nine or any of the examples described herein, wherein the header indicates a type of non-voice data to be transmitted or received during a silence period. Example twelve may include the subject matter of example nine or any of the examples described herein, wherein the one or more baseband processor are to generate one or more non-voice data packets to be sent to the remote UE during a silence period of the UE. Example thirteen may include the subject matter of example nine or any of the examples described herein, wherein the one or more baseband processors are to decode one or more non-voice data packets received from the remote UE during a silence period of the remote UE. Example fourteen may include the subject matter of example nine or any of the examples described herein, wherein the one or more baseband processors are to process a Silence Indicator Description (SID) frame received from the remote UE prior to receiving one or more non-voice data packets from the remote UE during a silence period of the remote UE. Example fifteen may include the subject matter of example nine or any of the examples described herein, wherein the voice call comprises a Voice over Long Term Evolution (VoLTE) call, an Internet Protocol (IP) telephony call, an Internet Protocol Multimedia Subsystem (IMS) call, or a Voice over Internet Protocol (VoIP) call, or a combination thereof. Example sixteen may include the subject matter of example nine or any of the examples described herein, wherein the non-voice data comprises message data, location data, or time data, or a combination thereof.

Example seventeen is directed to one or more computer readable media having instructions stored thereon that, if executed by a user equipment (UE), result in generating a voice call invite message for a remote UE, and storing the voice call invite message in a memory, wherein the voice call invite message includes a header p-use-silence-period to indicate that the UE is configured to transmit or receive non-voice data during a silence period of the voice call. Example eighteen may include the subject matter of example seventeen or any of the examples described herein, wherein the header indicates a type of non-voice data to be transmitted or received during a silence period. Example nineteen may include the subject matter of example seventeen or any of the examples described herein, wherein the instructions, if executed, further result in generating one or more non-voice data packets to be sent to the remote UE during a silence period of the UE. Example twenty may include the subject matter of example seventeen or any of the examples described herein, wherein the instructions, if executed, further result in decoding one or more non-voice data packets received from the remote UE during a silence period of the remote UE. Example twenty-one may include the subject matter of example seventeen or any of the examples described herein, wherein the instructions, if executed, further result in generating a Silence Indicator Description (SID) frame to be sent from the UE to the remote UE prior to sending one or more non-voice data packets to the remote UE during a silence period of the UE. Example twenty-two may include the subject matter of example seventeen or any of the examples described herein, wherein the voice call comprises a Voice over Long Term Evolution (VoLTE) call, an Internet Protocol (IP) telephony call, an Internet Protocol Multimedia Subsystem (IMS) call, or a Voice over Internet Protocol (VoIP) call, or a combination thereof. Example twenty-three may include the subject matter of example seventeen or any of the examples described herein, wherein the non-voice data comprises message data, location data, or time data, or a combination thereof.

Example twenty-four is directed to one or more computer readable media having instructions stored thereon that, if executed by a user equipment (UE), result in decoding a voice call invite message from a remote UE, and storing the voice call invite message in a memory, wherein the voice call invite message includes a header p-use-silence-period to indicate that the UE is configured to transmit or receive non-voice data during a silence period of the voice call. Example twenty-five may include the subject matter of example twenty-four or any of the examples described herein, wherein the header indicates a type of non-voice data to be transmitted or received during a silence period. Example twenty-six may include the subject matter of example twenty-four or any of the examples described herein, wherein the instructions, if executed, further result in generating one or more non-voice data packets to be sent to the remote UE during a silence period of the UE. Example twenty-seven may include the subject matter of example twenty-four or any of the examples described herein, wherein the instructions, if executed, further result in decoding one or more non-voice data packets received from the remote UE during a silence period of the remote UE. Example twenty-eight may include the subject matter of example twenty-four or any of the examples described herein, wherein the instructions, if executed, further result in processing a Silence Indicator Description (SID) frame received from the remote UE prior to receiving one or more non-voice data packets from the remote UE during a silence period of the remote UE, and storing the one or more non-voice data packets in the memory. Example twenty-nine may include the subject matter of example twenty-four or any of the examples described herein, wherein the voice call comprises a Voice over Long Term Evolution (VoLTE) call, an Internet Protocol (IP) telephony call, an Internet Protocol Multimedia Subsystem (IMS) call, or a Voice over Internet Protocol (VoIP) call, or a combination thereof. Example thirty may include the subject matter of example twenty-four or any of the examples described herein, wherein the non-voice data comprises message data, location data, or time data, or a combination thereof.

Example thirty-one is directed to an apparatus of a user equipment (UE) comprising means for generating a voice call invite message for a remote UE, and means for storing the voice call invite message in a memory, wherein the voice call invite message includes a header p-use-silence-period to indicate that the UE is configured to transmit or receive non-voice data during a silence period of the voice call. Example thirty-two may include the subject matter of example thirty-one or any of the examples described herein, wherein the header indicates a type of non-voice data to be transmitted or received during a silence period. Example thirty-three may include the subject matter of example thirty-one or any of the examples described herein, further comprising means for generating one or more non-voice data packets to be sent to the remote UE during a silence period of the UE. Example thirty-four may include the subject matter of example thirty-one or any of the examples described herein, further comprising means for decoding one or more non-voice data packets received from the remote UE during a silence period of the remote UE. Example thirty-five may include the subject matter of example thirty-one or any of the examples described herein, further comprising means for generating a Silence Indicator Description (SID) frame to be sent from the UE to the remote UE prior to sending one or more non-voice data packets to the remote UE during a silence period of the UE. Example thirty-six may include the subject matter of example thirty-one or any of the examples described herein, wherein the voice call comprises a Voice over Long Term Evolution (VoLTE) call, an Internet Protocol (IP) telephony call, an Internet Protocol Multimedia Subsystem (IMS) call, or a Voice over Internet Protocol (VoIP) call, or a combination thereof. Example thirty-seven may include the subject matter of example thirty-one or any of the examples described herein, wherein the non-voice data comprises message data, location data, or time data, or a combination thereof.

Example thirty-eight is directed to an apparatus of a user equipment (UE) comprising means for decoding a voice call invite message from a remote UE, and means for storing the voice call invite message in a memory, wherein the voice call invite message includes a header p-use-silence-period to indicate that the UE is configured to transmit or receive non-voice data during a silence period of the voice call. Example thirty-nine may include the subject matter of example thirty-eight or any of the examples described herein, wherein the header indicates a type of non-voice data to be transmitted or received during a silence period. Example forty may include the subject matter of example thirty-eight or any of the examples described herein, further comprising means for generating one or more non-voice data packets to be sent to the remote UE during a silence period of the UE. Example forty-one may include the subject matter of example thirty-eight or any of the examples described herein, further comprising means for decoding one or more non-voice data packets received from the remote UE during a silence period of the remote UE. Example forty-two may include the subject matter of example thirty-eight or any of the examples described herein, further comprising means for processing a Silence Indicator Description (SID) frame received from the remote UE prior to receiving one or more non-voice data packets from the remote UE during a silence period of the remote UE, and means for storing the one or more non-voice data packets in the memory. Example forty-three may include the subject matter of example thirty-eight or any of the examples described herein, wherein the voice call comprises a Voice over Long Term Evolution (VoLTE) call, an Internet Protocol (IP) telephony call, an Internet Protocol Multimedia Subsystem (IMS) call, or a Voice over Internet Protocol (VoIP) call, or a combination thereof. Example forty-four may include the subject matter of example thirty-eight or any of the examples described herein, wherein the non-voice data comprises message data, location data, or time data, or a combination thereof. Example forty-five is directed to machine-readable storage including machine-readable instructions, when executed, to realize an apparatus as recite in any example herein.

Although the claimed subject matter has been described with a certain degree of particularity, it should be recognized that elements thereof may be altered by persons skilled in the art without departing from the spirit and/or scope of claimed subject matter. It is believed that the subject matter pertaining to bandwidth utilization during silence frames and many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

1-30. (canceled)

31. An apparatus of a user equipment (UE), comprising:
one or more baseband processors to generate a voice call invite message for a remote UE; and
a memory to store the voice call invite message;
wherein the voice call invite message includes a header p-use-silence-period to indicate that the UE is configured to transmit or receive non-voice data during a silence period of the voice call.

32. The apparatus of claim 31, further comprising a radio-frequency (RF) transceiver to transmit the voice call invite message to the remote UE via a core network.

33. The apparatus of claim 31, wherein the header indicates a type of non-voice data to be transmitted or received during a silence period.

34. The apparatus of claim 31, wherein the one or more baseband processor are to generate one or more non-voice data packets to be sent to the remote UE during a silence period of the UE.

35. The apparatus of claim 31, wherein the one or more baseband processors are to decode one or more non-voice data packets received from the remote UE during a silence period of the remote UE.

36. The apparatus of claim 31, wherein the one or more baseband processors are to generate a Silence Indicator Description (SID) frame to be sent from the UE to the remote UE prior to sending one or more non-voice data packets to the remote UE during a silence period of the UE.

37. The apparatus of claim 31, wherein the voice call comprises a Voice over Long Term Evolution (VoLTE) call.

38. The apparatus of claim 31, wherein the non-voice data comprises message data, location data, or time data, or a combination thereof.

39. An apparatus of a user equipment (UE), comprising:
one or more baseband processors to decode a voice call invite message from a remote UE; and
a memory to store the call invite message;
wherein the call invite message includes a header p-use-silence-period to indicate that the UE is configured to transmit or receive non-voice data during a silence period of the voice call.

40. The apparatus of claim 39, further comprising a radio-frequency (RF) transceiver to receive the voice call invite message from the remote UE via a core network, and to transmit a 200 OK message to the remote UE via the core network in reply to the voice call invite message.

41. The apparatus of claim 39, wherein the header indicates a type of non-voice data to be transmitted or received during a silence period.

42. The apparatus of claim 39, wherein the one or more baseband processor are to generate one or more non-voice data packets to be sent to the remote UE during a silence period of the UE.

43. The apparatus of claim 39, wherein the one or more baseband processors are to decode one or more non-voice data packets received from the remote UE during a silence period of the remote UE.

44. The apparatus of claim 39, wherein the one or more baseband processors are to process a Silence Indicator Description (SID) frame received from the remote UE prior to receiving one or more non-voice data packets from the remote UE during a silence period of the remote UE.

45. The apparatus of claim 39, wherein the voice call comprises a Voice over Long Term Evolution (VoLTE) call.

46. The apparatus of any of claim 39, wherein the non-voice data comprises message data, location data, or time data, or a combination thereof.

47. One or more non-transitory computer readable media having instructions stored thereon that, if executed by a user equipment (UE), result in:
generating a voice call invite message for a remote UE; and
storing the voice call invite message in a memory;
wherein the voice call invite message includes a header p-use-silence-period to indicate that the UE is configured to transmit or receive non-voice data during a silence period of the voice call.

48. The one or more non-transitory computer readable media of claim 47, wherein the header indicates a type of non-voice data to be transmitted or received during a silence period.

49. The one or more non-transitory computer readable media of claim 47, wherein the instructions, if executed, further result in generating one or more non-voice data packets to be sent to the remote UE during a silence period of the UE.

50. The one or more non-transitory computer readable media of claim 47, wherein the instructions, if executed, further result in decoding one or more non-voice data packets received from the remote UE during a silence period of the remote UE.

51. The one or more non-transitory computer readable media of claim 47, wherein the instructions, if executed, further result in generating a Silence Indicator Description (SID) frame to be sent from the UE to the remote UE prior to sending one or more non-voice data packets to the remote UE during a silence period of the UE.

52. The one or more non-transitory computer readable media of claim 47, wherein the voice call comprises a Voice over Long Term Evolution (VoLTE) call.

53. The one or more non-transitory computer readable media of claim 47, wherein the non-voice data comprises message data, location data, or time data, or a combination thereof.
